(19) United States
(12) Patent Application Publication
(10) Pub. No.: US 2014/0263023 A1
(43) Pub. Date: Sep. 18, 2014

(54) Filtration Media and Filter Therefor

(71) Applicant: Hayward Industries, Inc., Elizabeth, NJ (US)

(72) Inventor: Kevin Potucek, Far Hills, NJ (US)

(73) Assignee: Hayward Industries, Inc., Elizabeth, NJ (US)

(21) Appl. No.: 14/210,804

(22) Filed: Mar. 14, 2014

Related U.S. Application Data
(60) Provisional application No. 61/794,987, filed on Mar. 15, 2013.

(51) Int. Cl. B01D 65/02

(52) U.S. Cl. CPC B01D 65/02
USPC 210/269

(57) ABSTRACT

A filtration media and a filter assembly therefor is provided. The filtration assembly comprising a tank comprising an upper portion, a bottom portion, a water inlet in the upper portion, a water outlet, and a holding chamber at the bottom portion of the tank, a grate positioned within the tank and separating the holding chamber from the upper portion of the tank, and a filtration media positioned within the upper portion of the tank, the filtration media comprising a filter membrane having a lubricious surface for automatic de-caking of particulate when a pump connected to the tank is turned off, wherein when the pump is turned off the particulate de-cakes from the filtration media and drops through the grate to the holding chamber.

### CROSS-REFERENCE TO RELATED APPLICATION

This application claims priority to U.S. Provisional Patent Application No. 61/794,987 filed on Mar. 15, 2013, which is incorporated herein by reference in its entirety.

### BACKGROUND

1. Field of the Disclosure

The present disclosure relates to a filtration media and filter therefor.

2. Background

Pool filter performance is generally defined by three elements: quality of filtration, ease of cleaning, and time between cleaning (filter cycle).

With respect to the quality of filtration, the finer the particulate the filter will capture from the pool water being filtered is considered to be a higher quality of filtration. Generally, Diatomaceous Earth (DE) filters provide the highest quality of water filtration, capturing particulate as small as 5 microns. Cartridge filters are considered the second highest quality of filtration, capturing particles as small as 10-15 microns. Sand filters are the poorest quality of filtration, capturing particles in the 20-30 micron range. All filters, particularly sand and cartridge clean better as they get dirty, but the pressure loss in the system goes up measurably as they get dirty.

With respect to the ease of cleaning, there are pros and cons to each method of filtration as it relates to cleaning the media. Sand is often considered the easiest because you simply reverse the flow of water through the filter, “backwashing” the filtered particulate to waste. The backwash is achieved by simply changing the position of a valve and then returning it to the original position after the backwash. The next easiest filtration method is likely DE. It is still backwashable but requires a recharge of the DE after backwash. The least easiest to clean is cartridge filters. They are a messy, manual cleaning. This manual cleaning does, however, require the least amount of water for cleaning.

Finally, with respect to the time between cleaning (filter cycle), the longer between required cleaning the better. Depending on size, DE or cartridge filters offer the longest time between cleaning, typically 3-6 months. Sand filters require back-washing every week or two.

### SUMMARY

The present disclosure relates to a filtration media and a filter assembly therefor. The filtration assembly comprising a tank comprising an upper portion, a bottom portion, a water inlet in the upper portion, a water outlet, and a holding chamber at the bottom portion of the tank, a grate positioned within the tank and separating the holding chamber from the upper portion of the tank, and a filtration media positioned within the upper portion of the tank, the filtration media comprising a filter membrane having a lubricious surface for automatic de-caking of particulate when a pump connected to the tank is turned off, wherein when the pump is turned off the particulate de-cakes from the filtration media and drops through the grate to the holding chamber.

### BRIEF DESCRIPTION OF THE DRAWINGS

The foregoing features of the disclosure will be apparent from the following Detailed Description, taken in connection with the accompanying drawings, in which:

FIGS. 1 and 2 are top and side views, respectively, of the filtration media of the present disclosure and a sample filter in which the filtration media of the present invention could be used.

### DETAILED DESCRIPTION

The present invention relates to a novel filtration media and a filter assembly therefor.

FIGS. 1 and 2 are top and side views, respectively, of the filtration media of the present disclosure and a sample filter in which the filtration media of the present invention could be used. The filtration assembly 10 comprises a tank 12 comprising, an upper portion 16, a bottom portion 22, a water inlet 14 (e.g., unfiltered water entrance) in the upper portion 16, a water outlet 18 (e.g., filtered water exit), and a holding chamber 20 at the bottom portion 22 of the tank 12, a grate 24 positioned within the tank 12 and separating the holding chamber 20 from the upper portion 16 of the tank 12, and a filtration media 30 positioned within the upper portion 16 of the tank 12, the filtration media 30 comprising a filter membrane having a lubricious surface 31 for automatic de-caking of particulate when a pump connected to the tank 12 is turned off, wherein when the pump is turned off the particulate de-cakes from the filtration media and drops through the grate 24 to the holding chamber 20. The tank 12 including a tank lid 32 and a filter base/stand 34 (FIG. 1 being a top view with the tank lid 32 removed). The filtration assembly further comprising a drain port 36 (e.g., drain/cleanout port) at a bottom of the tank for removal of the particulate in the holding chamber 20, with a removeable 38 clean-out cap at an end thereof. The pressure differential could be terminated by turning off a pump providing water flow 40 into the upper portion 16 of the tank 12 through the water inlet 14.

The principle of the filtration media 30 of the present invention (also referred to herein as “4^{th} Media Filter”) is as follows:

The filtration media 30 has filtration quality of DE. It is easier to clean than sand. It has extended filter cycles (time between cleaning) surpassing DE and large cartridge. It includes a two-dimensional filtration media similar to non-woven polyester in current cartridge filters.

The media 30 includes a two-dimensional fabric/membrane like non-woven polyester. A lubricious surface 31 is included to promote automatic de-caking of particulate when pump is turned off (off cycle) and pressure differential is terminated.

The fabric/membrane is designed to deliver to 5 micron filtration when clean.

The filter area is designed to hold particulate for one turnover filtration cycle without greater than 5 psi increase in pressure drop.

Because the filter media 30 is designed to hold only one day's (one turnover's) particulate, square footage of media should be able to be dramatically reduced, eliminating the need for deep pleats or even eliminating pleats altogether. The media 30 may simply be wrapped around a cylinder with supporting “mesh” as required. Reduced area and pleat elimination reduces cost as well as promotes auto-decaking.

The filtration assembly 10 of the present invention is discussed as follows. The filter tank 12 should have a “stagnant holding chamber” 20 at the bottom 22 of the tank 12 providing ample “storage” for months of filtered particulate that has decaked from the media 30 during the “off cycle”. This chamber 20 is segregated from the upper portion 16 of the tank 12 (portion with 4th media cylinder) by a grate 24 that allows particulate to drop through during the “off cycle” but also provides a baffle that inhibits the agitation of stored particulate during the active filtration cycle. This grate 24 may be little more than a 1″ thick grid with 1″ square openings.

The tank bottom has a drain port 36 that allows the easy pressurized or unpressurized removal of the stagnant particulate every 3, 6 or even 12 months. Required “flush” would consume less water than would the cleaning of a conventional cartridge.

Preliminarily, the “4th media” is a Donaldson Teflon membrane, but other fabrics/membranes may yield superior cost/performance/reliability.

Further features of the media include:

Porex cartridges and/or perflex fingers

“Goretex-like” Teflon coating of non-woven polyester will deliver cost effective, DE quality filtration while providing water conservation and infrequent service common to large cartridge filtration. Low friction coating and fewer pleats will allow particulate to de-cake during off cycle and collect in “dirt collection well” in bottom of filter. New media coating may also be suited for Perflex and vertical grid, while eliminating DE.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is desired to be protected is set forth in the following claims.

What is claimed is:

1. A filtration assembly comprising:
a tank comprising an upper portion, a bottom portion, a water inlet, a water outlet, and a holding chamber at the bottom portion of the tank;
a grate positioned within the tank and separating the holding chamber from the upper portion of the tank; and
a filtration media positioned within the upper portion of the tank, the filtration media comprising a filter membrane having a lubricious surface for automatic de-caking of particulate when a pump connected to the tank is turned off,
wherein when the pump is turned off the particulate de-cakes from the filtration media and drops through the grate to the holding chamber.

2. The filtration media of claim 1, wherein the membrane is pleatless.

3. The filtration media of claim 1, wherein the membrane comprises non-woven polyester.

4. The filtration media of claim 1, wherein the lubricious surface comprises a low friction coating.

5. The filtration assembly of claim 1, wherein the filtration media is cylindrical.

6. The filtration assembly of claim 5, wherein the membrane is wrapped around a cylinder with supporting mesh.

7. The filtration assembly of claim 5, wherein the tank is cylindrical, and the filtration media is co-axially aligned with the tank.

8. The filtration assembly of claim 1, wherein the grate comprises a baffle which inhibits agitation of particulate stored in the holding chamber during an active filtration cycle.

9. The filtration assembly of claim 1, wherein the grate is a grid.

10. The filtration assembly of claim 1, wherein openings of the grate are sized to permit particulate to pass through.

11. The filtration assembly of claim 1, further comprising a drain port at a bottom of the tank for removal of the particulate in the holding chamber.
